(19) United States
(12) Patent Application Publication
(10) Pub. No.: US 2007/0253701 A1
(43) Pub. Date: Nov. 1, 2007

(54) OPERATION ASSIST TOOL FOR PHOTOGRAPHIC DEVICE

(75) Inventor: Satoshi Takami, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/740,560

(22) Filed: Apr. 26, 2007

(30) Foreign Application Priority Data
Apr. 27, 2006 (JP) 2006-123447

(51) Int. Cl. G03B 17/00; G03B 17/38

(52) U.S. Cl. 396/419; 396/504

(57) ABSTRACT

An operation assist tool for a photographic device having an operation member, according to the present invention, includes an operation command member and a fastening tool. The operation command member commands the operation member to carry out an operation of the photographic device. The fastening tool has a body to which the photographic device is fastened, and an elastic plate to which the operation command member is attached.

### BACKGROUND OF THE INVENTION

1. Field of the Invention

The present invention relates to operation assist tools for a photographic device, especially to those to which a member to assist with the operations of the photographic device is attached.

2. Description of the Related Art

To prevent a hand shake when a subject is photographed by a single-lens reflex camera and so on, photographing by using a cable release which is connected to the photographic device fixed to a tripod and so on, is known. On the other hand, for photographing with a photographic device such as a compact digital camera to which a cable release cannot be attached, using an attachment tool to attach a cable release to the predetermined position with respect to the stationary photographic device is considered.

Switches which can be operated with a limited exertion of force, or which can be operated by a body part other than the hands of a user, such as the chin of a handicapped person who may experience difficulties applying or controlling a force necessary to manually operate conventional switches due to physical handicaps, are known (hereinafter, such a switch is referred to as a welfare switch). A welfare switch, for example, is one which has a wide area to be depressed and can be operated with a very small force, one which is simply operable with a very small force, or one which can be operated by an exhalation of a user.

To a user who cannot easily control a force for operating a cable release and so on, a photographing operation is difficult even when a cable release is used, as well as a conventional photographing operation without a cable release. Further, when a user experiences difficulty controlling a force for operating a cable release and other operation members, for example due to a physical handicap, the user may operate a cable release attached to a photographic device via an attachment tool, with a force larger than the level required. In such a case, the operation members, including the cable release, may be broken with an excess applied force.

A welfare switch cannot be constituted with a conventional attachment tool for attaching a cable release to the predetermined position of the photographic device, because a handicapped user would still be required to operate such a conventional attachment tool with a suitable force. Further, a conventional attachment tool cannot be used with various types of photographic devices because operation members, including a release button, are located in different positions on different photographic devices and such a conventional attachment tool cannot be made adjustable for the different photographic devices.

### SUMMARY OF THE INVENTION

Therefore, an objective of the present invention is to provide an operation assist tool for a photographic device which will ease an operation of an operation member, such as a cable release, for a user who cannot apply a suitable force to operate the operation members, which will also protect the photographic device, and which can be widely used.

An operation assist tool for a photographic device having an operation member, according to the present invention, includes an operation command member and a fastening tool. The operation command member commands the operation member to carry out an operation of the photographic device. The fastening tool has a body to which the photographic device is fastened, and an elastic plate to which the operation command member is attached.

### BRIEF DESCRIPTION OF THE DRAWINGS

The present invention will be better understood from the description of the preferred embodiments of the invention set forth below, together with the accompanying drawings, in which:

FIG. 1 is a front view of an operation assist tool of the first embodiment that is used for a digital camera;

FIG. 2 is a plan view of an elastic plate of the first embodiment fastened to a body;

FIG. 3 is a section view of the elastic plate fastened to the body, taken along a line III-III of FIG. 2;

FIG. 4 is a front view of the operation assist tool and the digital camera, where a power switch is depressed with a suitable force via a cable release attached to the elastic plate;

FIG. 5 is a front view of the operation assist tool and the digital camera, where the power switch is depressed with a force larger than a level required, via the cable release attached to the elastic plate;

FIG. 6 is a front view of a comparative example of an operation assist tool to which the elastic plate is not provided;

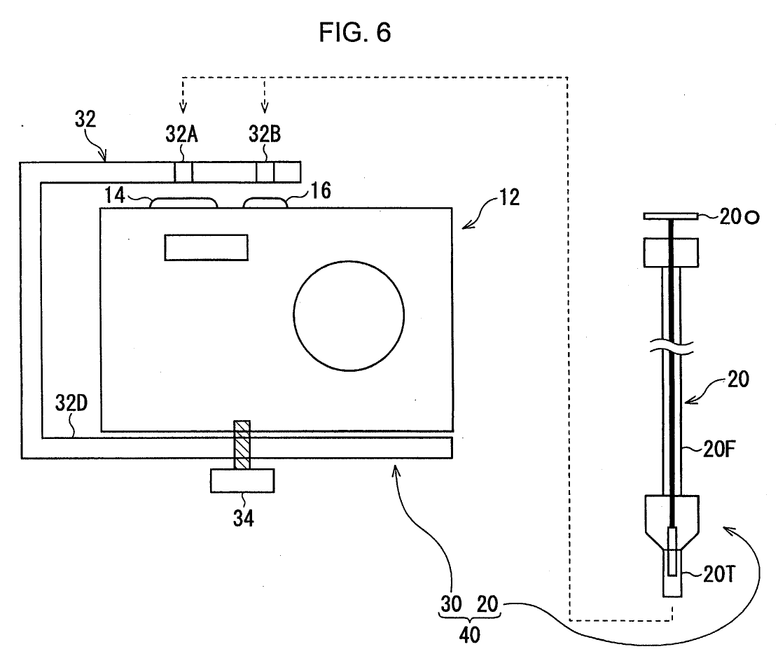

FIG. 7 is a perspective view of an elastic plate of the second embodiment as seen from the upper side;

FIG. 8 is a side view of the elastic plate of the second embodiment in use;

FIG. 9 is a section view of the elastic plate, taken along a line IX-IX of FIG. 8;

FIG. 10 is a front view of an operation assist tool of the third embodiment, that is used for the digital camera;

FIG. 11 is a front view of the operation assist tool of the third embodiment, where the length of a body is adjusted in the up and down direction;

FIG. 12 is a front view of an operation assist tool of the fourth embodiment, that is used for the digital camera; and

FIG. 13 is a side view of the operation assist tool of the fourth embodiment, that is used for the digital camera.

### DESCRIPTION OF THE PREFERRED EMBODIMENTS

Hereinafter, the embodiments of the present invention are described with reference to the attached drawings.

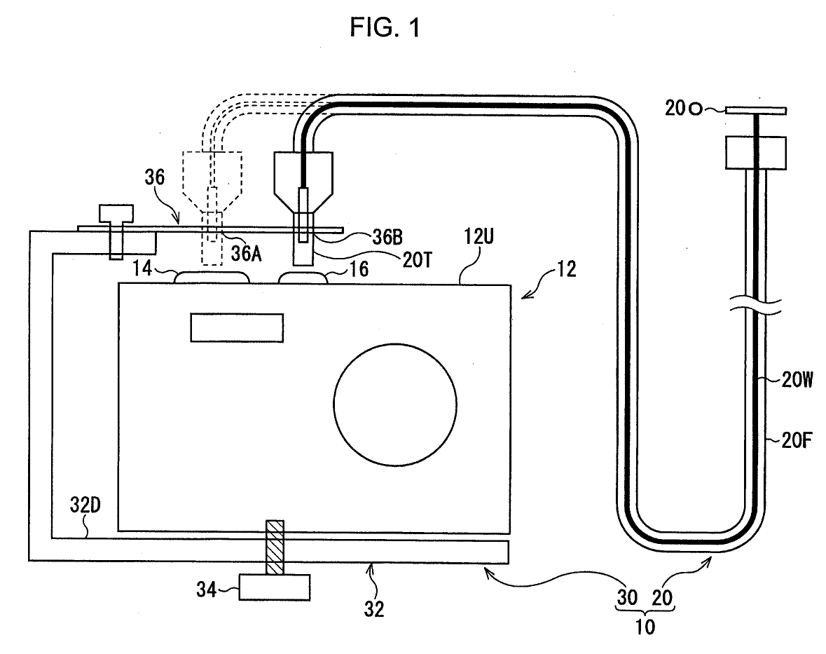

As represented in FIG. 1, the operation assist tool 10 includes a cable release 20 as an operation command member, and a fastening tool 30. The cable release 20 is used to assist operations of a release button 14 or a power switch 16 (an operation member), both provided on the upper surface 12U of a digital camera 12. In the fastening tool 30, a body 32 is provided. The digital camera 12 is fastened to the fastening surface 32D of the body 32 by a screw 34.

In the cable release 20, a wire 20W, an end 20T from which the wire 20W inside the release 20 extends, an operation portion 200 which a user operates, and a flexible portion 20F connecting the end 20T and the operation portion 200, are provided. Note that the wire 20W, which is located inside the flexible portion 20F and other parts, is not visible. However, the wire 20W is presented in FIG. 1 and following figures for ease of explanation.

In the fastening tool 30, an elastic plate 36 to which the cable release 20 is attached to the predetermined position, is provided. The elastic plate 36 is attached to the body 32. The elastic plate 36 is made of the same sturdy material as the body 32, for example resins such as reinforced plastic, or metals such as stainless steel. The elastic plate 36 is much thinner than the body 32 and has the property of elasticity. In the elastic plate 36, first and second attachment holes 36A, 36B are provided. The end 20T of the cable release 20 is inserted into one of the first and second attachment holes 36A, 36B, so that the cable release 20 is attached to the elastic plate 36. Note that the end 20T inserted into the first attachment hole 36A is represented by a broken line, and the end 20T inserted into the second attachment hole 36B is represented by a solid line, in FIG. 1.

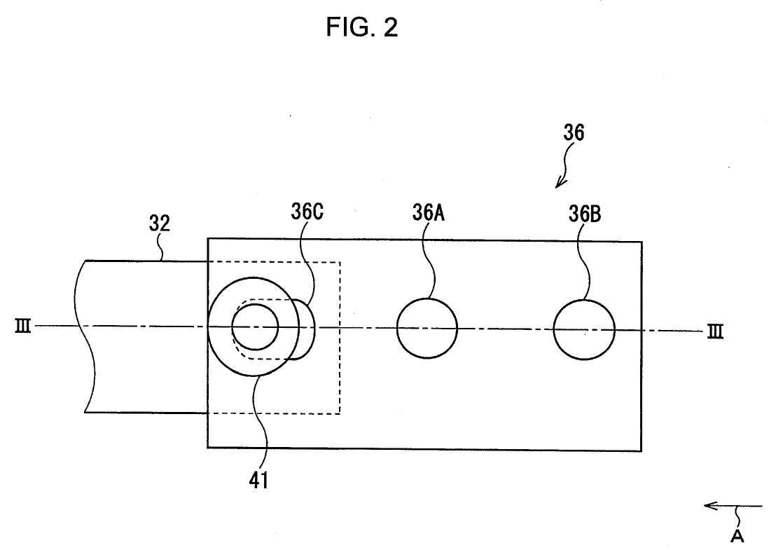

In the elastic plate 36, a hole 36C by which to attach the elastic plate 36 to the body 32 is provided (see FIG. 2). The elastic plate 36 is attached to the body 32 with a plate attachment screw 41 that is screwed into the body 32 via the hole 36C. The hole 36C has an elongated shape extending in the horizontal direction of the fastened digital camera 12, that is in the longitudinal direction of the elastic plate 36, so that the attachment position of the elastic plate 36 to the body 32 is adjustable as explained below.

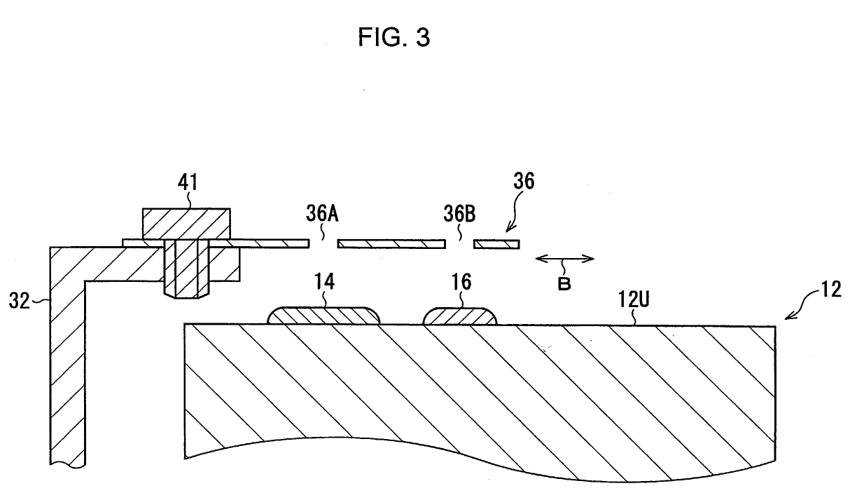

First, the plate attachment screw 41 running through the end of the hole 36C, as represented in FIG. 2, is released so that the elastic plate 36 is shifted in the longitudinal direction of the elastic plate 36 as represented by the arrow A. After that, the elastic plate 36 is attached to the body 32 again by using the plate attachment screw 41, thus adjusting the attachment position of the elastic plate 36. Therefore, positional gaps between the release button 14 or the power switch 16 and the elastic plate 36, due to the positional gap of the digital camera 12 generated when the digital camera 12 was initially fastened to the body by a screw 34, can be cancelled by adjusting the attachment position of the elastic plate 36 as represented by the arrow B (see FIG. 3). Therefore, by adjusting the attachment position of the elastic plate 36, the operation assist tool 10 can also be used with cameras having different arrangements of the release button 14 or power switch 16 than that of digital camera 10.

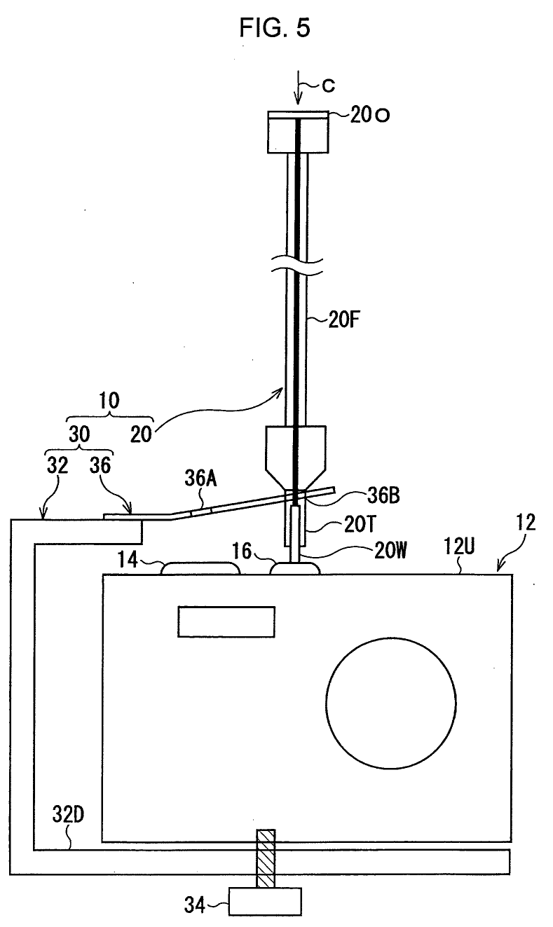

When the operation portion 200 of the cable release 20 attached to the elastic plate 36 is depressed, the wire 20W extends from the end 20T so that the power switch 16 is depressed by the wire 20W. In this operation, when a user cannot easily detect the fully depressed position of the power switch 16 due to a handicapped hand or other reason, or when a user depresses the operation portion 200 with a body part of which the applied force cannot be easily adjusted, such as a chin or elbow, the force applied to the operation portion 200 may not be adjusted. When the force applied to the operation portion 200 is larger than the level required, the elastic plate 36 is bent upwards as represented in FIG. 5, due to the resisting force of the excess force applied to the operation portion 200. Therefore, a part of the excess force applied to the operation portion 200 is absorbed by the transformation of the elastic plate 36, and all of the force applied by the user is not applied the power switch 16 so that the breakage of the power switch 16 is prevented.

On the other hand, in an operation assist tool 40 of the comparative example which does not have the elastic plate 36 and which has first and second attachment holes 32A, 32B provided in a body 32 that is inelastic, when an excess force is applied to the operation portion 200, the excess force is transmitted to the release button 14 or the power switch 16 without any protective absorption via the wire 20W. As a result, the release button 14 or the power switch 16 may be broken.

As explained above, in the first embodiment the release button 14, the power switch 16, and other operation members can be effectively protected even when the cable release 20 is operated by an excessive force.

Further, by adjusting the position, size, shape, or number of the first and second attachment holes 36A and 36B, operation command members other than the cable release 20 can also be used. For example, the operation portion 200 of the cable release 20 may be depressed by using a welfare switch, such as one which has a wide area to be depressed and which can be operated with a very small force, one which can be operated by an exhalation of a user, or one which is operable by a motor driven by a body part other than the hands. Further, screw grooves may be provided in the first and second attachment holes 36A and 36B not only for the cable release 20, but also for other conventional cable releases having a screw thread at the end portion to be screwed thereby. In this case, to attach the cable release having the screw thread at the end portion to the thin elastic plate 36, nuts having a screw groove corresponding to the screw thread at the end portion of the cable release may be used for putting the elastic plate 36 between them.

Next, the second embodiment and primarily the differences between it and the first embodiment are explained. Note that in the following figures, the same components as those of the first embodiment are identified by the same numerals.

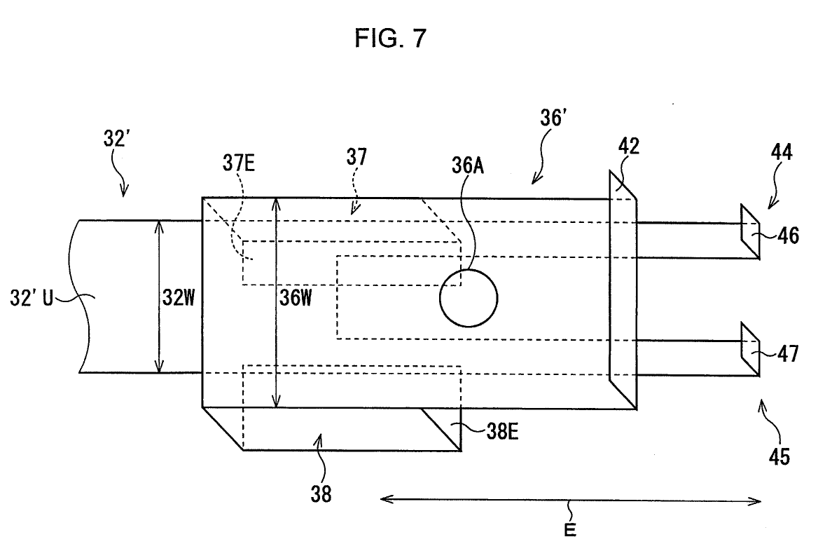

In the second embodiment, as represented in FIG. 7, the elastic plate 36′ is slidably attached to the attachment surface 32′U of the body 32′, which is different from the first embodiment. That is, the elastic plate 36′ is slidable in a direction parallel to the attachment surface 32′U and the upper surface 12U of the fastened digital camera 12, as represented by the arrow E. By sliding the elastic plate 36′, the attachment position of the cable release 20 and other operation members can be adjusted so that only one attachment hole, that is the first attachment hole 36A, needs be provided in the elastic plate 36′, in contrast to the first embodiment.

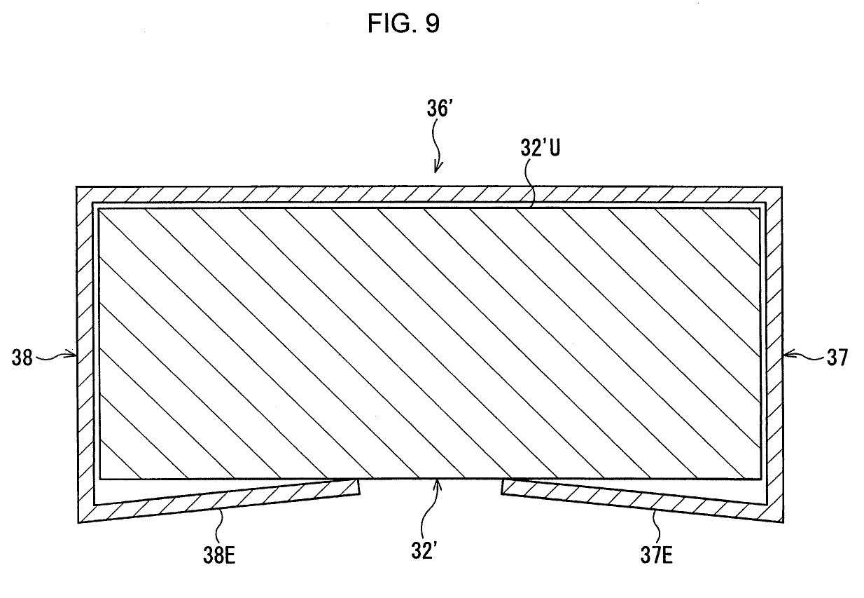

In the elastic plate 36′, first and second guiding plates 37 and 38 (guiding members) are provided. The attachment surface 32′U is put between by the first and second guiding plates 37 and 38 extending downwards to guide the slide direction of the elastic plate 36′. In FIGS. 7 and 9, openings between each of the first and second guiding plates 37 and 38 and the attachment surface 32′U are illustrated for convenience of the explanation; however, each of the first and second guiding plates 37 and 38 actually fit snugly up against the attachment surface 32′U.

Each of the first and second guiding plates 37 and 38 has an extension part 37E and 38E, respectively, at the end thereof.

Below the body 32′, the extension parts 37E and 38E extend towards the middle of the lower surface of the body 32′, and the end of the extension parts 37E and 38E make contact with the body 32′ (see FIGS. 7 and 9). By providing the extension parts 37E and 38E as explained above, the elastic plate 36′ is reliably attached to the body 32′ and is slidable with a suitable amount of friction with the body 32′. Note that the first and second guiding plates 37 and 38 may be provided at the side of the body 32′ to put the both ends of the elastic plate 36 between them.

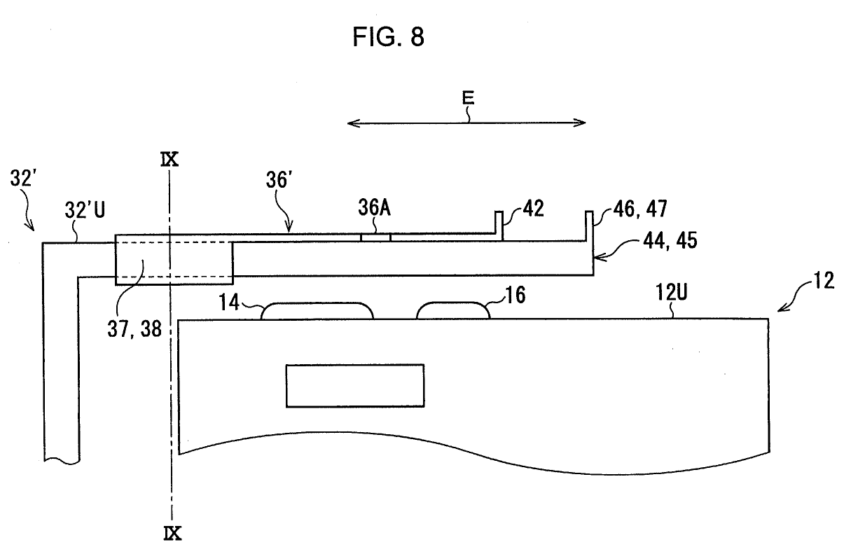

At the end of the elastic plate 36′, a holding plate 42 (a holding member) that is held by a user to ease a sliding operation of the elastic plate 36′ performed by the user, is provided. A user can easily hold onto the holding plate 42 so that the sliding operation of the elastic plate 36′ is carried out easily. Further, at the end of the body 32′, first and second engaging members 44 and 45 (a position determination member) that determine a limit of the position for sliding of the elastic plate 36′ (see FIG. 8). The first and second engaging members 44 and 45 prevent a detachment of the elastic plate 36′ from the body 32′.

The first and second engaging members 44 and 45 extend along the ends of the elastic plate 36′ so as not to come into contact with the cable release 20 attached to the attachment hole 36A and other members. The limit of the position for sliding of the elastic plate 36′ is set to be the position where first and second engaging plates 46 and 47 of the first and second engaging members 44 and 45, respectively extending upwards, contact to the holding plate 42 (see FIGS. 7 and 8).

Note that, for example, the attachment hole 36A is located just above the center of the power switch 16 of the digital camera 12 (see FIG. 8) when the holding plate 42 comes into contact with the first and second engaging plates 46 and 47. In this way, by providing the first and second engaging members 44 and 45, the elastic plate 36′ can be easily moved to a suitable position for operating a frequently used operation member, so that the operationality of the operation assist tool 10 is improved. Further, when an excessive force is applied to an operation member such as the power switch 16 for depression, the first and second engaging members 44 and 45 can be easily transformed with the elastic plate 36′ because the first and second engaging members 44 and 45 extend only along the ends of the elastic plate 36′. Therefore, the breakage of the operation members including the power switch 16 can be prevented also in the second embodiment.

As explained above in the second embodiment, in regard to a photographic devices such as the digital camera 12 on which a plurality of operation members including the release button 14 and the power switch 16 are provided on a surface thereof, operation command members such as the cable release 20 can be easily attached to the suitable position so that the operationality of the operation assist tool 10 is improved.

Note that in the second embodiment, the operation members such as the release button 14 and power switch 16 are reliably protected because the elastic plate 36′ and the first and second engaging members 44 and 45 are effectively transformed under the application of an excessive applied force, similarly to the first embodiment.

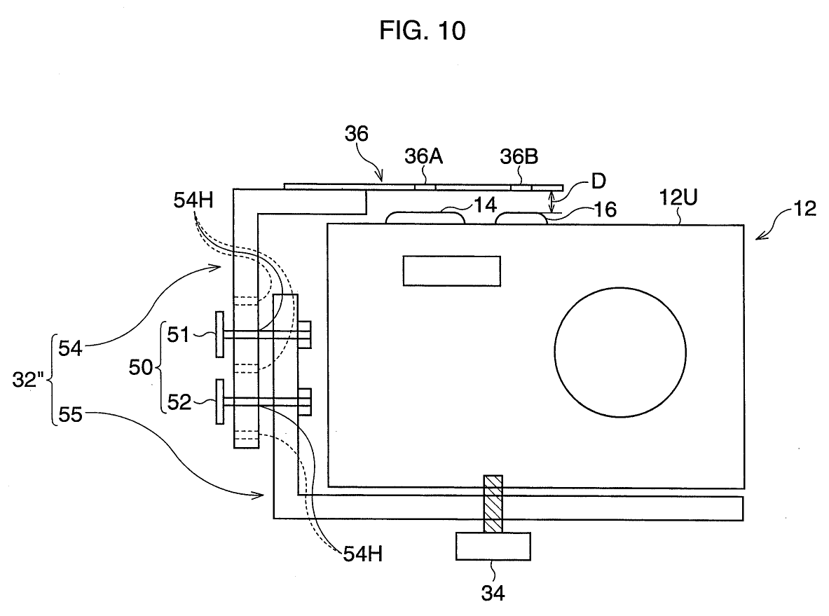

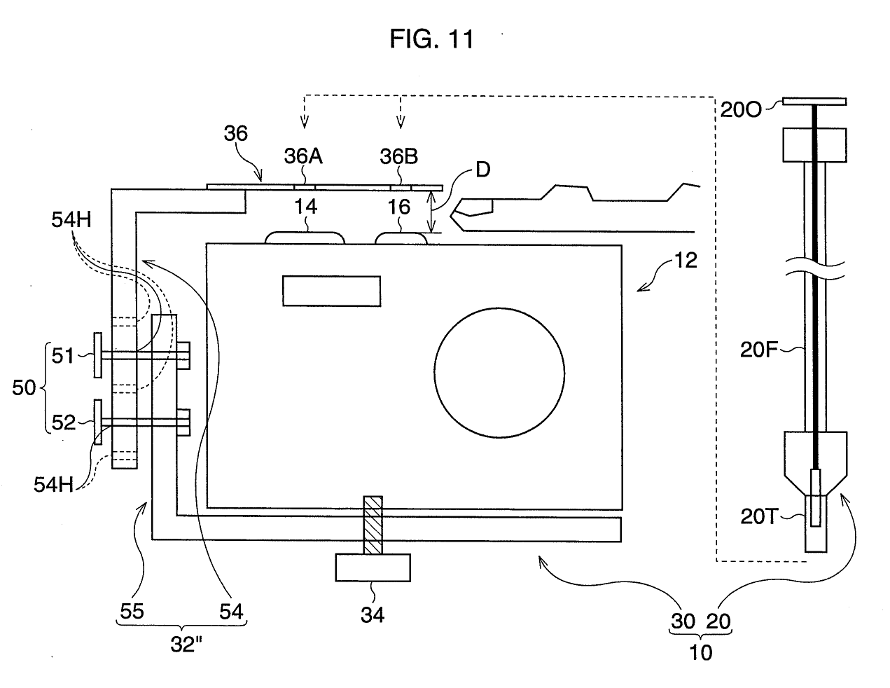

Next, the third embodiment and primarily the differences between it and the above explained embodiments are explained. Note that in the following figures, the same components as those or components corresponding to those of the first and second embodiments are identified by the same reference numerals. In FIGS. 10 and 11 for the third embodiment, the end 20T of the cable release 20 that is attached to the elastic plate 36 is omitted to clearly represent the openings between the elastic plate 36 and operation members.

In the third embodiment, as represented in FIGS. 10 and 11, which is different from the first embodiment, is an adjustment mechanism 50 (a distance adjustor) to adjust the up and down length of the body 32″ is provided, and the body 32″ is divided into a first body 54 and a second body 55 that are connected with each other by the adjustment mechanism 50. The adjustment mechanism 50 is provided to adjust the distance D which is a distance between the elastic plate 36 and the release button 14 or power switch 16 of the stationary digital camera 12. The reasons for providing the adjustment mechanism 50 is to adjust the length of the body 32″ in the up and down direction to correspond to the length of the digital camera 12 in the same direction, and to make the operation members be directly operable by a finger of a user (see FIG. 11) in the event a problem develops in the cable release 20 and other members. Through an opening between the elastic plate 36 and operation members, the operation members can be operated directly by a finger of a user.

When the distance D between the elastic plate 36 and the operation members is too short, as represented in FIG. 10, first and second body attachment screws 51 and 52 provided in the adjustment mechanism 50 are released, the relative position of the first body 54 with respect to the second body 55 is shifted, and the first and second body attachment screws 51 and 52 are then again screwed into the first and second bodies 54 and 55. For this operation, in the first body 54, a plurality of screw holes 54H in which the attachment screws 51 and 52 can be fixed are provided, with a spacing between them shorter than the distance between the first and second body attachment screws 51 and 52 represented in FIG. 10. In this embodiment, the up and down length of the body 32″ can be adjusted by selecting appropriate screw holes 54H in which to fix the attachment screws 51 and 52. As a result, the distance D between the elastic plate 36 and the operation members becomes long enough so that the operation members can be operated directly by a finger of a user (see FIG. 11), in addition to being operable via the cable release 20 that can be used similarly to the above explained embodiments.

Note that in FIGS. 10 and 11, the distance between the screw holes 54H neighboring each other is about half the distance between the first and second body attachment screws 51 and 52. However, when more precise adjustments are necessary for the distance D between the elastic plate 36 and the operation members than what is possible in the third embodiment, the distance between each of the neighboring screw holes 54H can be shortened to be less than that of this embodiment. Further, to adjust the distance D precisely, the screw holes 54H may be elongated.

As explained above in the third embodiment, because the digital camera 12 is fastened to the body 32″ with the opening is provided between the elastic plate 36 and the operation members, the operation members are reliably operated even when a problem occurs in the cable release 20 or other operation command members.

Next, the fourth embodiment and primarily the differences between it and the above explained embodiments are explained.

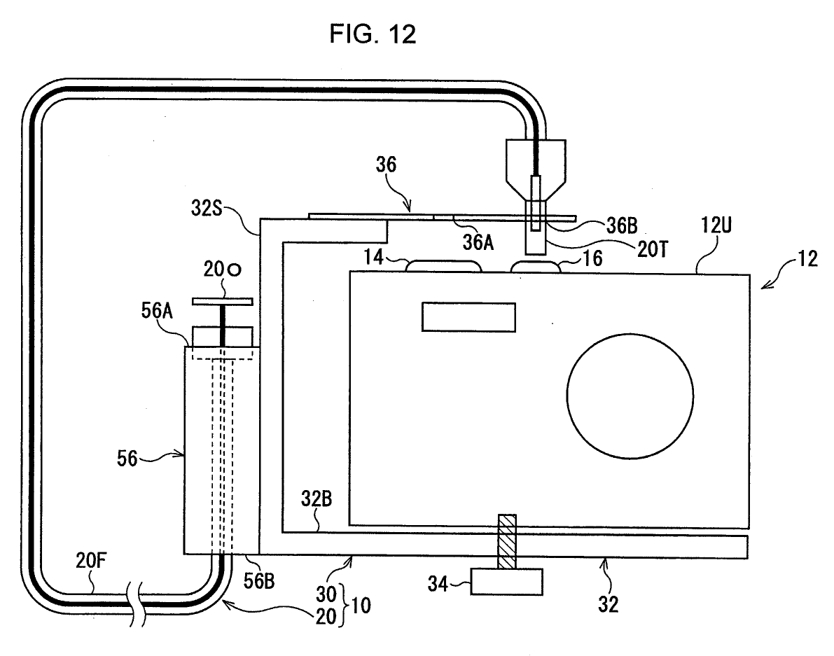

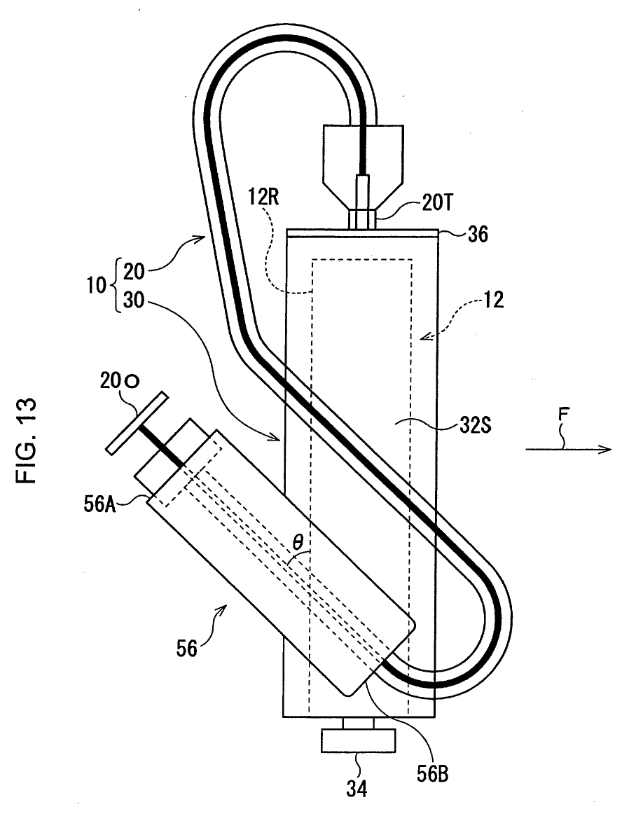

In the fourth embodiment, as represented in FIGS. 12 and 13, an attachment member 56 to which the cable release 20, welfare switches, or other operation command members can be attached is provided on the side surface 32S of the body 32, which is different from the first embodiment. In the attachment member 56, a clip mechanism (not shown) to hold the body 32 is provided, so that the attachment member 56 can be detachably attached to the side surface 32S of the body 32 in accordance with needs.

On the upper side of the attachment member 56, an upper side opening 56A in which the operation command member is inserted is provided. When the operation command member is inserted in the upper side opening 56A, the operation portion 200 thereof extends over the upper side opening 56A. For example, the cable release 20 is inserted in the upper side opening 56A, the end 20T of the cable release 20 can be pulled out from a bottom side opening 56B. At this time, the operation portion 200 is held in the predetermined position in the attachment member 56. The end 20T of the cable release 20 is inserted in and attached to the first attachment hole 36A and so on (see FIG. 13), similarly to the above explained embodiments. Note that the arrow F in FIG. 13 represents the front side of the digital camera 12.

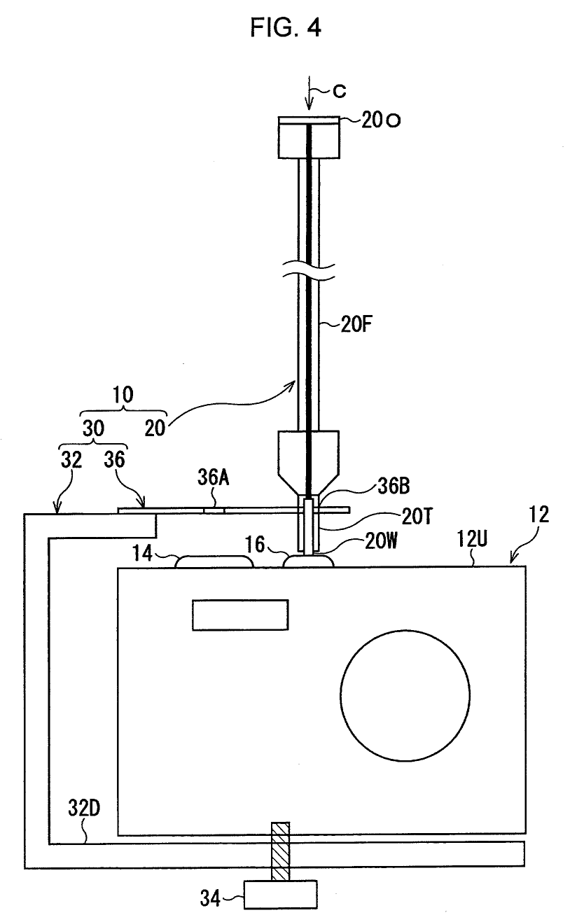

The attachment member 56 is designed so that the operation portion 200 of the cable release 20 held in the attachment member 56 inclines towards a rear surface 12R of the digital camera 12. Therefore, the operation portion 200 that is inclined towards the rear surface 12R of the digital camera 12 by the inclination angle θ, is operated. This is because applying a force obliquely below with a horizontal component is easier than applying a force in a vertical direction in the above explained embodiment (see the arrow C in FIGS. 4 and 5), for a user who experiences difficulties operating the operation portion 200 and other members due to a physical handicap.

Note that the shape of the attachment member 56 is adjusted according to the subject operation command members such as the cable release 20. The inclination angle θ is also adjusted in the range below 90°, according to the shape of the operation portion 200 and so on, to improve the operationality of the cable release 20 as much as possible.

As explained above in the fourth embodiment, by providing the attachment member 56 that is detachable from the body 32, the operationality of the operation command member can be improved more than those in the other embodiments explained above.

The shapes of the cable release 20, the body 32, the elastic plate 36, and other members are not limited to those in the embodiments explained above. Further, a photographic device to which operation command members including the cable release 20, a welfare switch, and so on cannot be directly connected, can be a subject for use of the operation assist tool 10, which is not limited to the digital camera 12. For example, a silver-halide camera or a video camera may be the subject for use of the operation assist tool 10.

This invention is not limited to those described in the preferred embodiments, namely, various improvements and changes may be made to the present invention without departing from the spirit and scope thereof.

The present disclosure relates to subject matter contained in Japanese Patent Application No. 2006-123447 (filed on Apr. 27, 2006), which is expressly incorporated herein, by reference, in its entirety.

1. An operation assist tool for a photographic device having an operation member, said operation assist tool comprising:
an operation command member that commands said operation member to carry out an operation of said photographic device; and
a fastening tool that has a body to which said photographic device is fastened and that has an elastic plate to which said operation command member is attached.

2. The operation assist tool according to claim 1, wherein an attachment hole by which said operation command member is attached, is provided in said elastic plate.

3. The operation assist tool according to claim 2, wherein said operation command member is screwed on said elastic plate.

4. The operation assist tool according to claim 1, wherein a hole that is to attach said elastic plate to said body, and that has elongated shape extending in the longitudinal direction of said elastic plate, is provided in said elastic plate, so that attachment position of said elastic plate to said body is adjustable.

5. The operation assist tool according to claim 1, wherein said elastic plate is slidably attached to said body.

6. The operation assist tool according to claim 5, wherein said elastic plate comprises a guiding member that guides a slide direction of said elastic plate.

7. The operation assist tool according to claim 5, wherein said body comprises a position determination member that determines a limit of the position for sliding of said elastic plate.

8. The operation assist tool according to claim 5, wherein said elastic plate comprises a holding member that is held by a user for a sliding operation thereof.

9. The operation assist tool according to claim 1, wherein said photographic device is fastened to said body so that an opening for a user to directly operate said operation member is provided between said elastic plate and said operation member.

10. The operation assist tool according to claim 9, wherein said body comprises a distance adjustor that adjusts the distance between said elastic plate and said operation member.

11. The operation assist tool according to claim 1, wherein said fastening tool further comprises an attachment member to which said operation command member is attached, in addition to said elastic plate.

12. The operation assist tool according to claim 1, wherein said operation member comprises at least one of a release button and a power switch of said photographic device.
